(19) United States
(12) Patent Application Publication
(10) Pub. No.: US 2005/0259304 A1
(43) Pub. Date: Nov. 24, 2005

(54) Hologram apparatus

(75) Inventor: Yoshihiro Someno, Tokyo (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/129,102

(22) Filed: May 13, 2005

(30) Foreign Application Priority Data
May 21, 2004 (JP) 2004-152133

(51) Int. Cl. G03H 1/08

(52) U.S. Cl. 359/35; 359/1

(57) ABSTRACT

A hologram apparatus includes a light source that emits a reference beam, and reads information recorded on a recording medium as holograms using the reference beam. In the hologram apparatus, the light source has a plurality of light emitting units each emitting the reference beam, and the recording medium is formed with plural hologram groups each having a plurality of holograms that correspond to the reference beams emitted from the light emitting units, respectively.

### BACKGROUND OF THE INVENTION

1. Field of the Invention

The present invention relates to a hologram apparatus for reading information recorded on a recording medium as holograms, and more specifically, to a hologram apparatus capable of reading a hologram group composed of a plurality of holograms by only one position adjustment.

2. Description of the Related Art

Conventionally, as a storage unit used in a computer or the like, storage units are widely being used in which information is two-dimensionally written onto a magnetic or optical recording medium. A hard disk is known as a storage unit using the magnetic recording medium, and a CD or DVD is known as a storage unit using the optical recording medium. These storage units have remarkably advanced in a recording density to meet a demand on large capacity. Also, as a means for much lager capacity, a storage unit using the principle of a hologram is under development.

The hologram apparatus reproduces information which is recorded on the recording medium as holograms in a page unit, while reading it. On the recording medium, coded information in a page unit is written as a pattern, such as a change of a refractive index. The pattern is a hologram formed by interference between an object beam and a reference beam in a recording apparatus, and to read the information from the recording medium, the reference beam only is incident on the recording medium, diffracted by the hologram pattern, and received in a photoelectric transducer, such as a CCD or a CMOS, thereby reproducing the written information. Such a hologram apparatus is disclosed in Japanese Unexamined Patent Application Publication No. 2003-43904.

However, the conventional hologram apparatuses have the following problems. In order to reproduce the information recorded in the hologram, it is necessary to make light having the same wavelength and angle as the reference beam when written onto the recording medium precisely incident on a location of the hologram. That is, locations of an optical system and the recording medium are required to be adjusted very precisely. But, in the conventional hologram apparatuses, the highly precise position adjustment is performed for every hologram, so that the reading speed is limited.

In addition, for the high density of the recording medium, multi-recording on the hologram is employed. As the multi-recording on the hologram, there is known multi-wavelength or multi-angle. However, in the case of the multi-wavelength, an expensive tunable laser is needed, and in the case of the multi-angle, an angle-varying mechanism is needed, so that in either case, manufacturing costs of the apparatus are greatly increased.

### SUMMARY OF THE INVENTION

The invention is designed to solve the above problems, and it is an object of the invention to provide a hologram apparatus of which reading speed is high and in which holograms recorded at high density can be reproduced by a simple mechanism.

In order to achieve the above object, according to an aspect of the invention, a hologram apparatus includes a light source that emits a reference beam, and reads information recorded on a recording medium as holograms using the reference beam. In the hologram apparatus, the light source has a plurality of light emitting units each emitting the reference beam, and the recording medium is formed with plural hologram groups each having a plurality of holograms that correspond to the reference beams emitted from the light emitting units, respectively.

Further, it is preferable that the hologram apparatus further include a condensing unit provided between the light source and the recording medium, and that the reference beams emitted from the light emitting units of the light source be respectively incident on the holograms of each hologram group corresponding to the light emitting units at different angles by the condensing unit.

Furthermore, it is preferable that the recording medium be connected to a medium driving unit that moves a relative location with respect to the light emitting units, and that the medium driving unit moves the recording medium so as to switch the hologram groups on which the light emitted from the light source is incident.

Moreover, it is preferable that the light source be connected to a light source driving unit that moves a relative location with respect to the recording medium, and that the light source driving unit move the light source so as to switch the hologram groups on which light is incident.

In addition, it is preferable that each of the holograms constituting the hologram group be arranged to overlap adjacent holograms each other.

Further, it is preferable that each of the light emitting units of the light source be a surface-emitting laser.

As described above, in the hologram apparatus according to the invention, a light source has a plurality of light emitting units each emitting the reference beam, and the recording medium is formed with plural hologram groups each having a plurality of holograms that correspond to the reference beams emitted from the light emitting units, respectively. Therefore, the plurality of holograms constituting the hologram group can be reproduced by only one position adjustment. Therefore, the position adjustment process can be simplified, and thus the reading speed can be increased.

Further, in the hologram apparatus according to the invention, a condensing unit is provided between the light source and the recording medium, and the reference beams emitted from the light emitting units of the light source are respectively incident on the holograms of each hologram group corresponding to the light emitting units at different angles by the condensing unit. Therefore, even if the respective holograms of each hologram group are arranged to overlap each other, the holograms can be independently reproduced by the different angles of the reference beams, which results in increasing the recording density of the holograms.

Furthermore, in the hologram apparatus according to the invention, the recording medium is connected to a medium driving unit that moves a relative location with respect to the light emitting units, or the light source is connected to a light source driving unit that moves a relative location with respect to the recording medium. Therefore, a switching operation between the hologram groups can be easily performed.

Moreover, in the hologram apparatus according to the invention, each of the holograms constituting the hologram group is arranged to overlap adjacent holograms each other. Therefore, the recording density of a recording medium can be increased.

In addition, in the hologram apparatus according to the invention, each of the light emitting units of the light source is a surface-emitting laser. Therefore, the light source including the plurality of the light emitting units can be easily manufactured by one process.

### BRIEF DESCRIPTION OF THE DRAWINGS

FIG. 1 is a conceptual view showing the configuration of a hologram apparatus according to a first embodiment of the invention;

FIGS. 2A to 2C are views showing a path of light emitted from each light emitting unit;

FIG. 3 is a perspective view of a light source;

FIG. 4 is a conceptual view showing the configuration of a hologram apparatus according to a second embodiment of the invention;

FIG. 5 is a conceptual view showing the configuration of a hologram apparatus according to a third embodiment of the invention;

FIG. 6 is a view showing another light source; and

FIG. 7 is a view showing yet another light source.

### DESCRIPTION OF THE PREFERRED EMBODIMENT

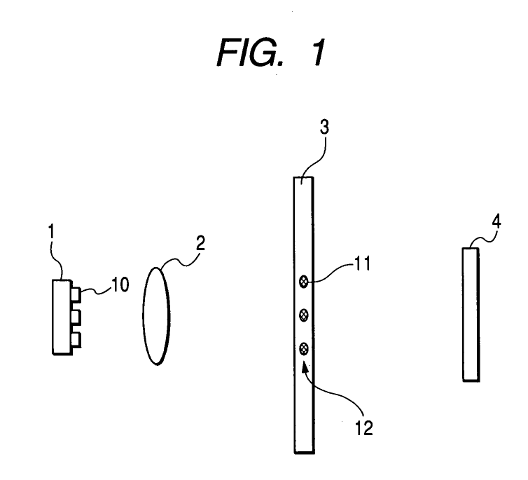

Hereinafter, embodiments of the invention will be described with reference to the accompanying drawings. FIG. 1 is a conceptual diagram showing a configuration of a hologram apparatus according to a first embodiment of the invention. As shown in FIG. 1, the hologram apparatus of this embodiment includes a light source 1 for generating a reference beam, a lens 2 serving as a condensing means for condensing light emitted from the light source 1, a recording medium 3 on which the light condensed by the lens 2 is incident, and a light receiving unit 4 for receiving the light emitted from the recording medium 3. In addition, the light receiving unit 4 is composed of a CCD or CMOS sensor.

The light source 1 has a plurality of light emitting units 10, and the light emitting units 10 generate light components having the same wavelength, respectively. The light emitting units 10 are two-dimensionally arranged on a plane, and the light components emitted from the light emitting units 10 are emitted from different locations. Here, a surface-emitting element, such as a surface-emitting laser, is used as the light emitting unit 10.

A plurality of holograms 11 are formed on the recording medium 3. Predetermined information is written on these holograms 11, and the information can be read by reproducing the holograms 11. Also, the plurality of holograms 11 are arranged adjacent to each other to form a hologram group 12.

The holograms 11 constituting the hologram group 12 are respectively formed such that they correspond to the light emitting units 10 one to one. That is, with respect to the light source 1 formed with three light emitting units 10 as shown in FIG. 1, three holograms 11 are formed to constitute the hologram group 12.

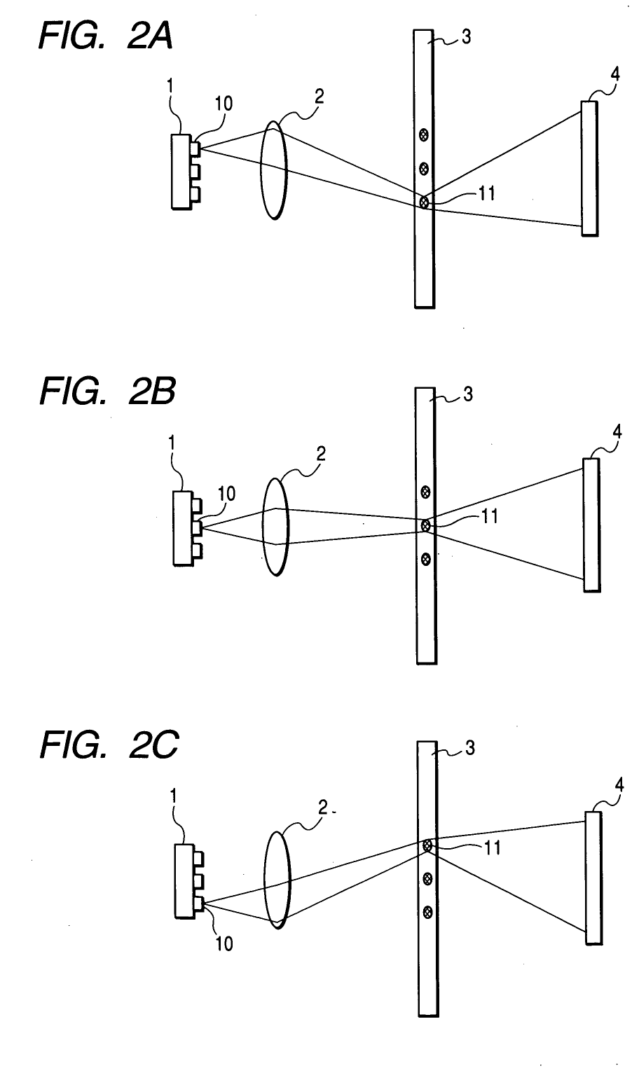

Next, it will be described in detail that light emitted from each of the light emitting units 10 is incident on each of the holograms 11 constituting the hologram group 12. FIGS. 2A to 2C show paths of the light emitted from the light emitting units 10, respectively.

As shown in FIG. 2A, light emitted from the light emitting unit 10, which is located at the upper side of the light source 1, is condensed onto the hologram 11 formed on the recording medium 3, by the lens 2. Here, the hologram 11 on which the light is incident is one located at the lower side among the holograms 11 constituting the hologram group 12.

Further, as shown in FIG. 2B, light emitted from the light emitting unit 10, which is located at the center of the light source 1, is condensed onto the hologram 11 formed on the recording medium 3, by the lens 2. Here, the hologram 11 on which the light is incident is one located at the center among the holograms 11 constituting the hologram group 12.

Furthermore, as shown in FIG. 2C, light emitted from the light emitting unit 10, which is located at a lower side of the light source 1, is condensed onto a hologram 11 formed on the recording medium 3, by the lens 2. Here, the hologram 11 on which the light is incident is one located at the upper side among the holograms 11 constituting the hologram group 12.

In addition, any light emitted from the holograms 11 is received by the light receiving unit 4. Since the respective holograms 11 are located at different positions, each light is emitted at a different angle. This can be accomplished by varying the incident angle of an object beam to correspond to a direction of the light receiving unit 4, when forming the holograms 11 on the recording medium 3. In this way, the holograms 11 can emit the reference beam as described above.

As such, the light, emitted from each of the light emitting units 10 of the light source 1, is incident on the corresponding hologram 11 of the hologram group 12. In addition, light components emitted from the light emitting units 10 are incident on the holograms 11 arranged in vertical symmetry. In this way, the holograms 11 are formed to correspond to the plurality of light emitting units 10, respectively, and thus the hologram group 12 is formed on the recording medium 3, so that it is possible to completely read the holograms 11 constituting the hologram group 12 by one position adjustment with respect to one hologram group 12.

A plurality of hologram groups 12 each having the plurality of holograms 11 are formed on the recording medium 3. For this reason, in order to reproduce each hologram 11 of a different hologram group 12, the recording medium 3 or the light source 1 is moved to switch the hologram groups 12. In order to move the recording medium 3, the recording medium 3 is fixed to a medium driving unit (not shown) which moves the relative location of the recording medium 3 with respect to the light emitting units 10 of the light source 1. On the other hand, in order to move the light source 1, the light source 1 is fixed to a light source driving unit (not shown) which moves the relative location of the light emitting units 10 of the light source 1 with respect to the recording medium 3.

After the position adjustment between the light source 1 and the recording medium 3 is performed to make light incident on a specific hologram group 12, light emitted from each of the light emitting units 10 of the light source 1 is sequentially incident on each of the holograms 11 constituting the hologram group 12. Since the light receiving unit 4 can reproduce only one kind of information, the plurality of light emitting units 10 of the light source 1 are not simultaneously emitted, but sequentially emitted.

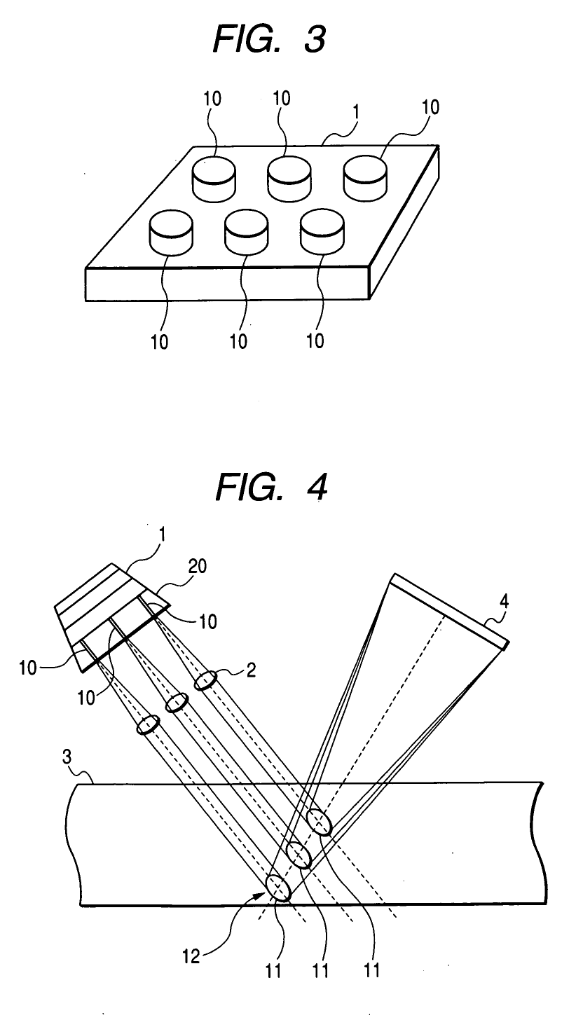

FIG. 3 shows a perspective view of the light source 1. Although three light emitting units 10 are arranged up and down in the light source 1 in FIGS. 1 and 2, they are actually arranged in an array shape on a plane, as shown in FIG. 3. Also, the arrangement is not limited to one shown in FIG. 3, circular or polygonal arrangement may be adopted. Even in this case, the light emitted from each of the light emitting units 10 is condensed by the lens 2 at a location symmetrical with respect to a center line of the light source 1.

With this configuration, the hologram group 12 composed of the plurality of holograms 11 can be collectively reproduced by the light source 1. Accordingly, only one position adjustment is enough for one hologram group 12, so that the position adjustment process can be simplified, which results in increasing the reading speed of the holograms 11.

Furthermore, the respective holograms 11 constituting the hologram group 12 are arranged to be separated from each other in FIGS. 1 and 2. However, the respective holograms 11 may be arranged to overlap adjacent holograms 11. Even though they are arranged to overlap each other, the incident angles of the reference beam for reproduction with respect to adjacent holograms 11 are different from each other, so that the holograms 11 can be individually reproduced. By arranging the holograms 11 to overlap each other, recording can be performed with higher density.

Next, a second embodiment of the invention will be described. FIG. 4 shows a conceptual view of a hologram apparatus according to this embodiment. As the light emitting unit 10 of the light source 1, a surface-emitting laser is used in the first embodiment, while a Fabry-Perot type laser is used in this embodiment. As shown in FIG. 4, the light source 1 of this embodiment is composed of a Fabry-Perot type laser array 20 in which a plurality of active layers, each generating light, are formed in an array shape. Light components having the same wavelength are emitted from the light emitting units 10, respectively.

The light components emitted from the light emitting units 10 become parallel light components by lenses 2, respectively, and are then incident on the recording medium 3. The recording medium 3 is formed with holograms 11 located at different positions in a thickness direction in correspondence with the light emitting units 10, and the holograms 11 constitute a hologram group 12. The holograms 11 diffract incident light in a reflection direction, and a light receiving unit 4 receives the emitted light. As such, in this embodiment, the lens 2 is provided for every light emitting unit 10, so that the respective light components are incident on the hologram group 12 in a straight line.

Further, the light source 1 can be manufactured at a lower cost by means of the Fabry-Perot type laser array 20. Also, the recording density of the holograms 11 can be increased by forming them at different locations in the thickness direction of the recording medium 3.

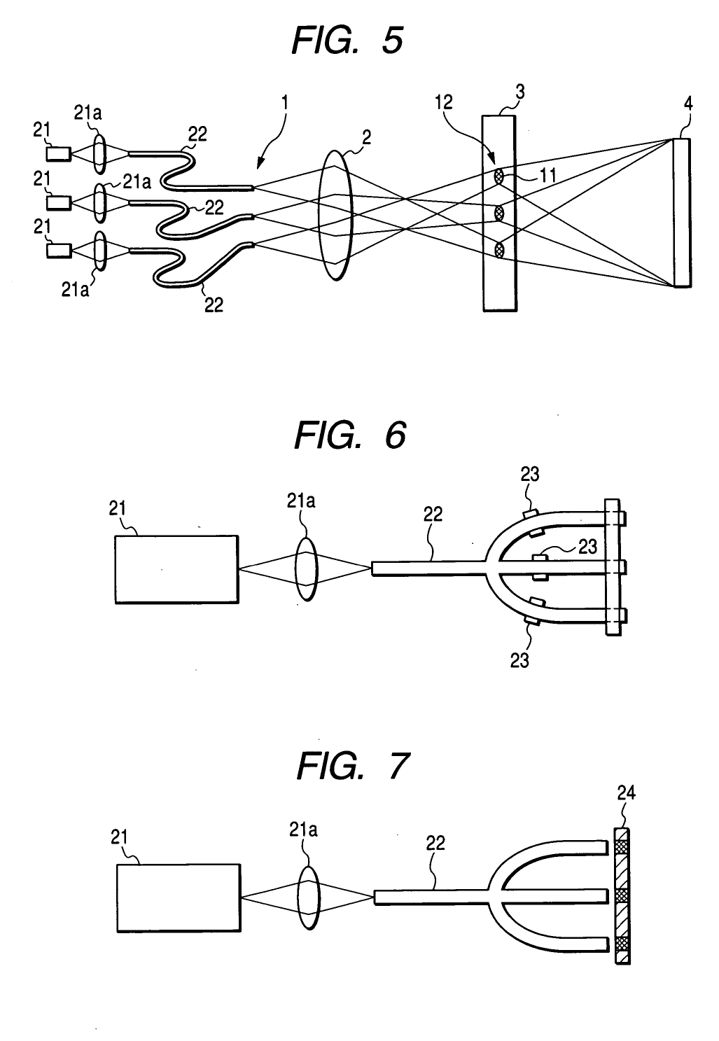

Next, a third embodiment of the invention will be described. FIG. 5 shows a conceptual view of a hologram apparatus of this embodiment. In a light source 1 of this embodiment, light components emitted from a plurality of laser chips 21 are guided by optical fibers 22, respectively. The light components emitted from the laser chips 21 are condensed by lenses 21a and then incident on the optical fibers 22, respectively. Emission terminals of the optical fibers 22 are arranged in an array shape, and the light components are emitted from the emission terminals toward a recording medium 3. In this embodiment, other configurations and optical paths are the same as in the first embodiment.

Further, the light source 1 may be constructed by using the optical fiber 22 as follows. FIG. 6 shows another example of the light source 1. In this case, one laser chip 21 is provided, and light is incident on an optical fiber 22 through a lens 21a. The optical fiber 22 is divided into three optical fibers, and optical switches 23 are respectively provided to the divided optical fibers 22, so that the optical fibers 22 can or cannot transmit light independently.

One of the optical switches 23 transmits light, and the others do not transmit light. And, by sequentially switching the optical switches 23 which transmit light, light is emitted from one of the emission terminals of the optical fibers 22. That is, each of the emission terminals of the optical fibers 22 serves as the light emitting unit 10 of the light source 1 in the first embodiment.

Furthermore, the light source 1 may have another configuration. FIG. 7 shows still another example of the light source 1. Also, in this case, one laser chip 21 is provided, and light is incident on an optical fiber 22 through a lens 21a. In addition, the light source in this example has the same structure as that in FIG. 6 in that the optical fiber 22 is divided. However, unlike the light source in FIG. 6, the optical switches 23 are not provided to the divided optical fibers 22, but an optical shutter 24 is provided instead around the emission terminals.

The optical shutter 24 is formed by providing, in an array shape, shutters that transmit or do not transmit the light components emitted from the emission terminals of the optical fibers 22 independently. The optical shutter 24 is operated such that light emitted from only one of the emission terminals of the optical fibers 22 is transmitted and light emitted from the other emission terminals thereof is not transmitted. In addition, by sequentially switching the emission terminals from which light is emitted, the optical shutter 24 serve as the light emitting unit 10 of the light source 1 in the first embodiment, similar to the structure shown in FIG. 6.

Having described the embodiments of the invention, it is to be understood that the invention is not limited thereto, but various changes and modifications thereof can be made without departing from the spirit or scope of the invention.

1. A hologram apparatus comprising a light source for emitting a reference beam and that reads information recorded on a recording medium as holograms using the reference beam,
wherein the light source has a plurality of light emitting units each emitting the reference beam, and
the recording medium is formed with plural hologram groups each having a plurality of holograms that correspond to the reference beams emitted from the light emitting units, respectively.

2. The hologram apparatus according to claim 1, further comprising:
a condensing unit provided between the light source and the recording medium,
wherein the reference beams emitted from the light emitting units of the light source are respectively incident on the holograms of each hologram group corresponding to the light emitting units at different angles by the condensing unit.

3. The hologram apparatus according to claim 1,
wherein the recording medium is connected to a medium driving unit that moves a relative location with respect to the light emitting units, and
the medium driving unit moves the recording medium so as to switch the hologram groups on which the light emitted from the light source is incident.

4. The hologram apparatus according to claim 1,
wherein the light source is connected to a light source driving unit that moves a relative location with respect to the recording medium, and
the light source driving unit moves the light source so as to switch the hologram groups on which light is incident.

5. The hologram apparatus according to claim 1,
wherein each of the holograms constituting each hologram group is arranged to overlap adjacent holograms each other.

6. The hologram apparatus according to claim 1,
wherein each of the light emitting units of the light source is a surface-emitting laser.
